(19) United States
(12) Patent Application Publication
(10) Pub. No.: US 2016/0200174 A1
(43) Pub. Date: Jul. 14, 2016

(54) AIR VENT ASSEMBLY AND METHOD

(71) Applicant: Airxcel, Inc., Wichita, KS (US)

(72) Inventors: Gary Tremer, Wichita, KS (US); Alan S. Lowe, Wichita, KS (US); Gregory G. Guinn, Wichita, KS (US); Robin Leach, Andover, KS (US)

(21) Appl. No.: 14/592,682

(22) Filed: Jan. 8, 2015

(51) Int. Cl. B60H 1/26; B61C 17/04

(52) U.S. Cl. CPC B60H 1/262; B61C 17/04

(57) ABSTRACT

An air vent assembly includes a rain cover that shields an air vent against entry of rain or other precipitation when a vent cap is in an open position to allow ventilation of a vehicle, such as a recreational vehicle, or a boat or other structure. A plurality of connectors formed as unitary portions of the rain cover and the air vent allow the rain cover to be attached and subsequently removed from the air vent.

### BACKGROUND OF THE INVENTION

The present invention relates generally to air vent assemblies and, more particularly, to an apparatus and method for removably connecting a rain cover to an air vent.

Recreational vehicles typically include an air vent assembly unit mounted in an opening formed in the roof of the vehicle. The air vent assembly allows air within the vehicle to be vented to the outdoors. The air vent assembly includes a frame that is mounted surrounding the opening and is secured to the roof structure by a mounting flange. A ventilation passage is formed within the frame and a vent cap is pivotally secured to the frame and is moveable between a closed position sealing the ventilation passage and an upwardly open position that permits air to flow through the ventilation passage. A vent fan may be mounted to the frame within the ventilation passage to draw air through the ventilation passage.

These air vent assembly are typically installed either at the factory or by the recreational vehicle dealer. A rain cover may be purchased for use with the air vent assembly. The rain cover is a box-like structure that attaches to the frame of the air vent assembly. The rain cover shields the air vent assembly to impede or prevent rain from passing downwardly through the ventilation passage when the vent cap of the air vent assembly is in the open position. One end of the rain cover is open and covered by a grille through which air may pass so that air within the vehicle may still be vented to the outdoors when the rain cover is attached to the exhaust fan unit.

Because the rain cover is often an optional accessory that is attached to the air vent assembly by the dealer or the vehicle owner after the initial installation of the air vent assembly, connectors must be provided to attach the rain cover to the air vent assembly. One common method of attaching the rain cover involves the use of metal brackets that are screwed or bolted to the air vent assembly and are then connected by a cotter pin or other fastener to mounting brackets integrally formed as part of the rain cover. The use of fasteners of this type is advantageous in that it allows the rain cover to be quickly disconnected from the air vent assembly for replacement if damaged or to permit access to the air vent assembly for inspection and maintenance.

During installation, the metal brackets described above must be carefully positioned on the air vent assembly to ensure they align with the mounting brackets on the rain cover. If any of the metal brackets are misaligned, it may not be possible to securely attach the rain cover to the air vent assembly. In some instances, it may not be possible to securely reposition the misaligned metal bracket because the initial screw or bolt hole formed in the air vent assembly may overlap with the screw or bolt hole formed when the metal bracket is repositioned. Because the installation of the metal brackets on the air vent assembly is time-consuming and requires considerable precision in the placement of the metal brackets, a need has thus developed for an improved apparatus and method for releasably securing the rain cover to the air vent assembly.

### SUMMARY OF THE INVENTION

In one aspect, the present invention is directed to an air vent assembly comprising an air vent, a rain cover, and at least one connector assembly for removably attaching the rain cover to the air vent. The air vent comprises a frame formed by interconnected sidewalls, a mounting flange that extends outwardly from the sidewalls, and a ventilation passage formed within the frame. The rain cover is formed from interconnected sidewalls, end walls and a top. The rain cover is generally open at the bottom and one of the end walls is open to the passage of air. The connector assembly comprises a first connector portion formed on the mounting flange, a second connector assembly formed on one of the sidewalls or end walls of the rain cover, and a fastener that interconnects the first connector portion with the second connector portion.

In one embodiment, the first connector portion is integrally formed with the mounting flange as a unitary, one-piece construction and the second connector portion is integrally formed with the sidewall or end wall of the rain cover as a unitary, one-piece construction. The first connector portion comprises an upstanding tab having an inner surface that faces toward and is spaced from one of the sidewalls of the frame and an outer surface that faces outwardly from said one of the sidewalls of the frame. The second connector portion comprises a foot having a notch positioned to tightly receive the tab of the first connector portion. At least one opening is provided in the foot and an aperture is provided in the tab. The opening and the aperture are aligned and receive the fastener that is removably inserted through the opening and the aperture to interconnect the first and second connector portions and removably secure the rain cover to the air vent.

In another aspect, the invention is directed to outward-facing knobs in the sides of the end wall of the rain cover that is open to the passage of air. The knobs have heads that are removably received within slots in the sidewalls of the rain cover. The heads may be positioned to align with and pass through slots and then rotated out of alignment with the slots to prevent the heads from passing back through the slots, thereby removably securing the end wall to the sidewalls. In another embodiment, the knobs may be rotated to cause the heads to frictionally engage with the sidewalls to removably secure the end wall to the sidewalls.

### BRIEF DESCRIPTION OF THE DRAWINGS

In the accompanying drawings that form part of the specification and are to be read in conjunction therewith and in which like reference numerals are used to indicate like parts in the various views:

FIG. 1 is a front perspective view of an air vent assembly made in accordance with one embodiment of the present invention and shown installed on a roof structure;

FIG. 2 is a rear perspective view of the air vent assembly;

FIG. 3 is a side perspective view of the air vent assembly with portions of the rain cover broken away to illustrate details of the air vent and showing a vent cap in an open position;

FIG. 4 is a side perspective view of the air vent assembly similar to that shown in FIG. 3 with portions of the rain cover broken away to illustrate details of the air vent and showing the vent cap in a closed position;

FIG. 5 is an exploded perspective view of the air vent assembly;

FIG. 6 is a front elevation view of the air vent assembly;

FIG. 7 is a side elevation view of the air vent assembly shown on an enlarged scale and taken in vertical section along line 7-7 in FIG. 6 to illustrate one of the connectors for releaseably securing the rain cover to the air vent; and

FIG. 8 is a fragmentary, exploded perspective view of the air vent assembly showing one of the connectors.

### DETAILED DESCRIPTION

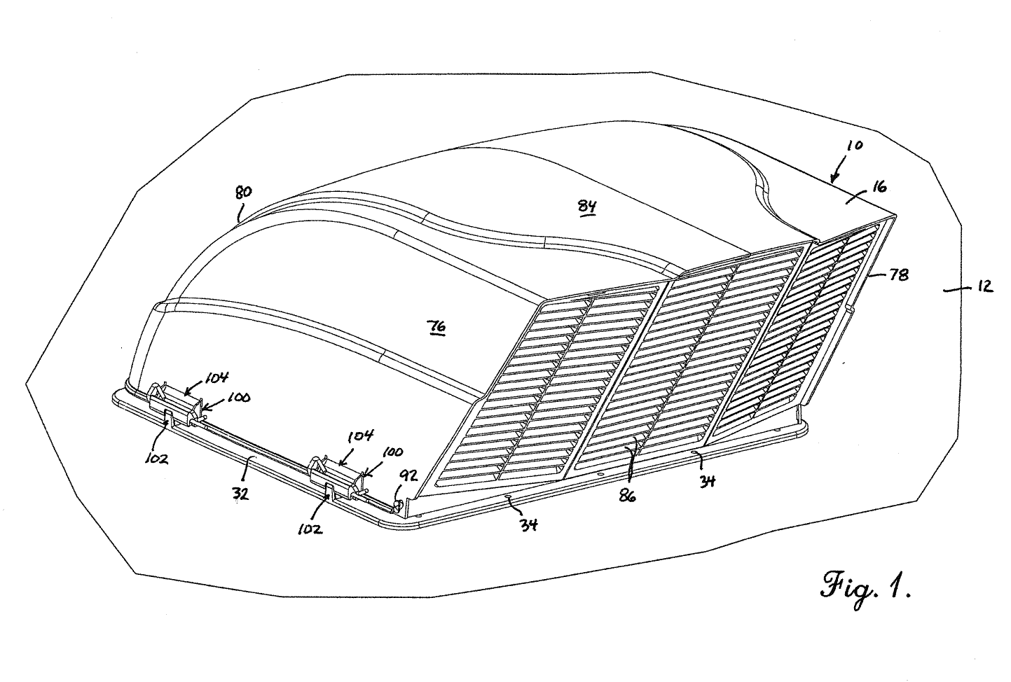

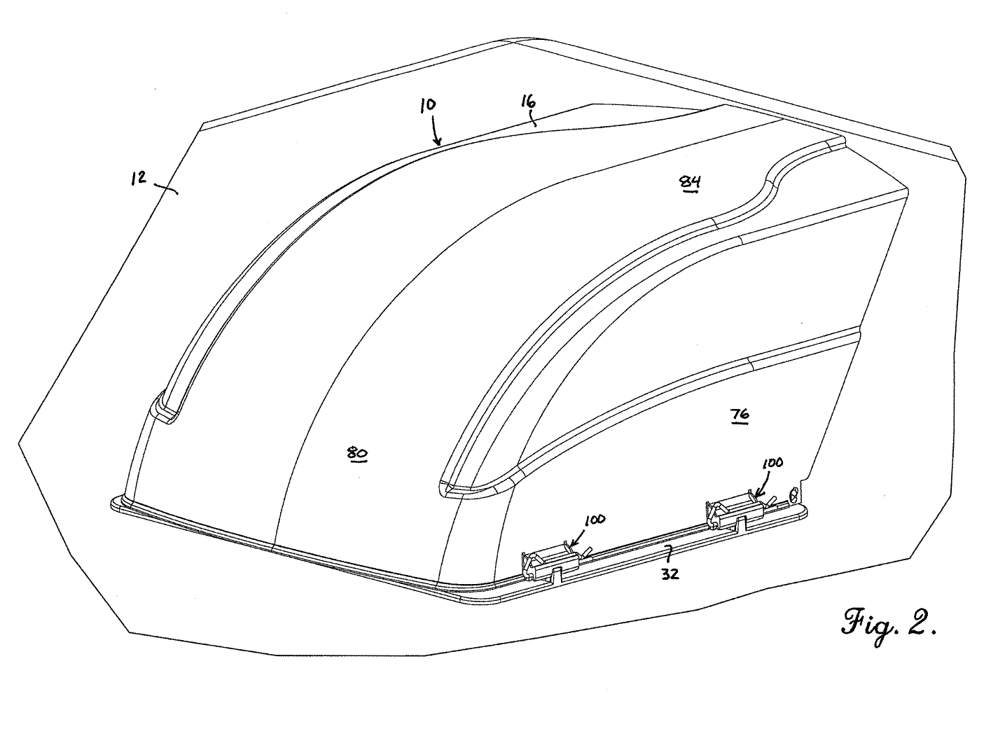

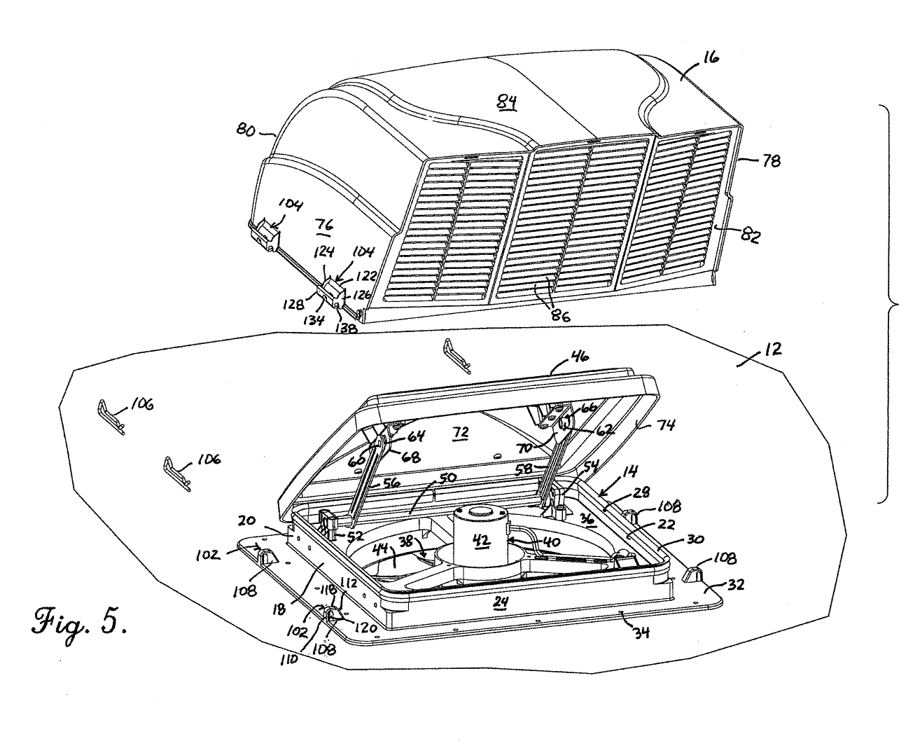

Turning now to the drawings in greater detail and initially to FIGS. 1-5, an air vent assembly constructed in accordance with the present invention is represented broadly by the numeral 10 and is shown positioned on a roof structure 12. The roof structure 12 in one embodiment is part of a recreational vehicle or another type of vehicle. In another embodiment, the roof structure 12 is part of a boat. As best shown in FIG. 5, the air vent assembly 10 includes an air vent 14 and a rain cover 16 that may be attached to the air vent 14 in a manner that allows for easy installation and subsequent detachment of the rain cover 16 from the air vent 14.

The air vent 14 includes a frame 18 that includes four vertical sidewalls 20, 22, 24 and 26 that are interconnected to form a square or other polygonal shape that closely conforms to the size and shape of an opening in the roof structure 12. An upper edge 28 presented by the sidewalls 20, 22, 24 and 26 is covered by a seal strip 30 having an inverted U-shaped cross-section. A mounting flange 32 surrounds and extends outwardly from the sidewalls 20, 22, 24 and 26 and is secured to the upper surface of the roof structure 12 by a plurality of screws 34 or other fasteners. A partition 36 extends inwardly from the sidewalls 20, 22, 24 and 26 and includes a central ventilation passage 38 that is normally circular in shape and allows air to be exhausted through the air vent 14 from within the recreational vehicle, other vehicle or boat to the outdoors. In one embodiment, a vent fan 40 is mounted is mounted to the frame 18 within the ventilation passage 38. The vent fan 40 includes an electric motor 42 that drives fan blades 44 mounted to a hub (not shown) to expel air through the ventilation passage 38.

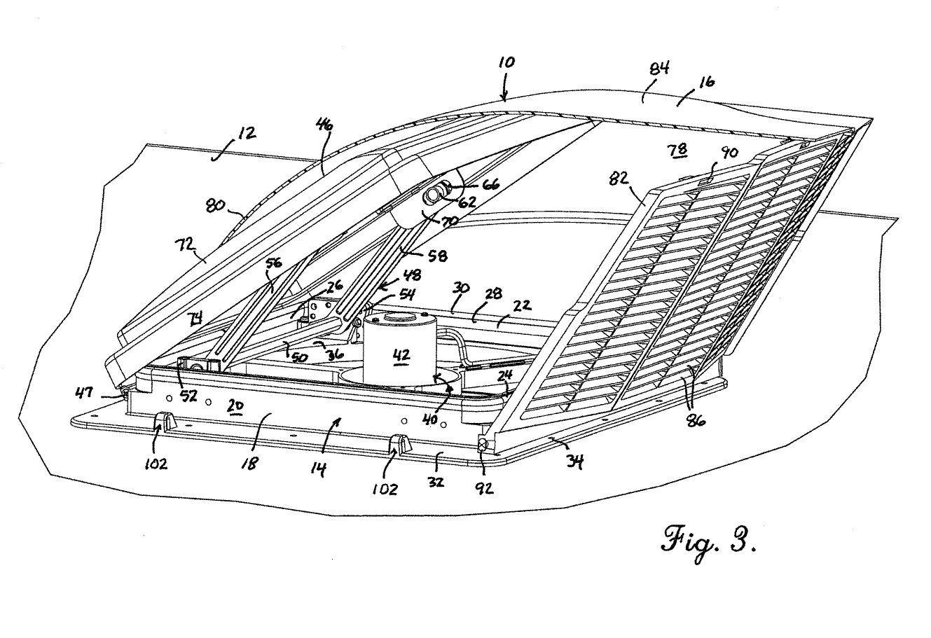

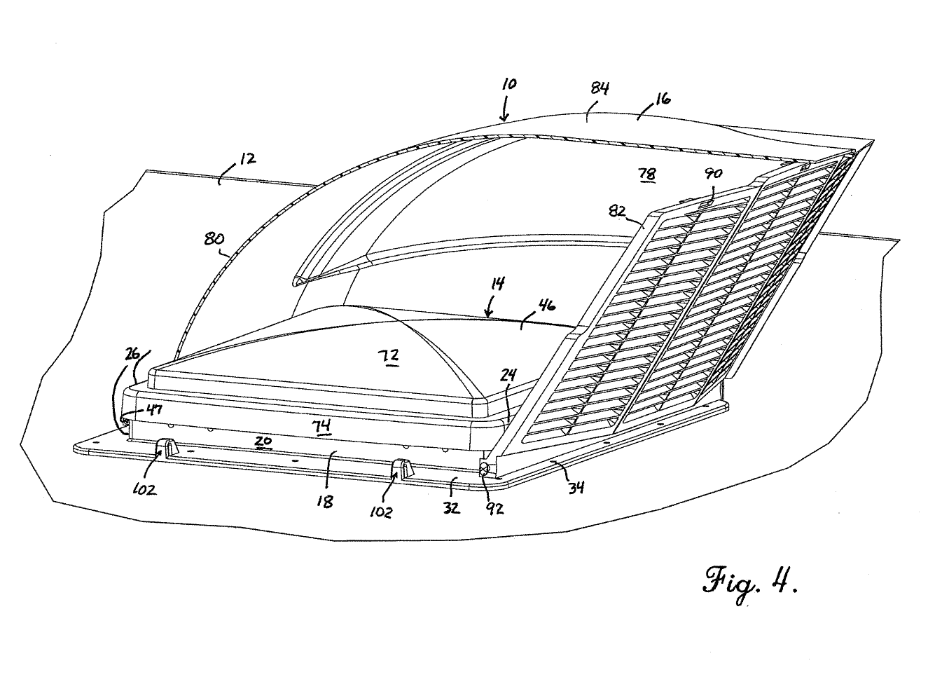

A vent cap 46 is mounted to the frame 18 by a hinge 47 that is positioned at one end of the vent cap 46 and allows pivoting movement of the vent cap 46 about a horizontal axis of the hinge 47. A pivot assembly 48 that is mounted to the partition 36 and an underside of the vent cap 46 is operable to cause the pivoting movement of the vent cap 46 between a closed position and an open position. In the closed position as shown in FIG. 4, an undersurface of the vent cap 46 is positioned against the seal strip 30 at the upper edge of the sidewalls 20, 22, 24 and 26 of the frame 18 to prevent air flow through the ventilation passage 38. In the open position as shown in FIGS. 3 and 5, the vent cap 46 is pivoted upwardly about the horizontal axis of the hinge 47 to allow air to flow through the ventilation passage 38. When the vent cap 46 is in the open position, it forms a preselected angle, such as 45° or greater, with respect to the mounting flange 32.

The pivot assembly 48 includes a horizontally-extending shaft 50 that is mounted at its opposite ends to brackets 52 and 54 that are fixed to an upper surface of the partition 36. The shaft 50 carries spaced-apart arms 56 and 58 that are keyed or otherwise fixed to the shaft 50 such that rotation of the shaft 50 causes the opposite ends of the arms 56 and 58 to raise and lower, depending on the direction of rotation of the shaft 50. Rotation of the shaft 50 can be effected by a torsion mechanism (not shown) and a linkage (not shown) that translates rotation of the torsion mechanism to rotation of the shaft. As but one example, the torsion mechanism may include a rotatable knob that is accessible within the structure and the linkage may include a worm drive.

The ends of the arms 56 and 58 that are opposite from the ends fixed to the shaft 50 carry pins 60 and 62, respectively, that are received within closed-ended slots 64 and 66 formed in brackets 68 and 70. The brackets 68 and 70 are mounted to an underside of a main body 72 of the vent cap 46 near the end of the vent cap 46 that is opposite from the hinge 47. As the shaft 50 rotates, the arms 56 and 58 rotate with the shaft 50 and the engagement of the pins 60 and 62 within the slots 64 and 66 causes the vent cap 46 to pivot about the axis of the hinge 47, thereby raising or lowering the opposite end of the vent cap 46 between the closed and open positions. The vent cap 46 includes a skirt 74 that extends downwardly about a perimeter of the main body 72 of the vent cap 46. The skirt 74 is positioned so that it is spaced slightly outwardly from and overlaps the sidewalls 20, 22, 24 and 26 of the frame 18 when the vent cap 46 is in the closed position.

The rain cover 16 has a generally box-like configuration that is open at the bottom and is formed from sidewalls 76 and 78, end walls 80 and 82, and a top 84. End wall 80 is forward-facing in the direction of travel of the recreational vehicle, other vehicle or boat and in one embodiment is curved to provide a more aerodynamic shape. The opposite end wall 82 includes louvers 86 that permit air that has entered the interior volume of the rain cover 16 from the ventilation passage 38 to exit the rain cover 16 through the end wall 82.

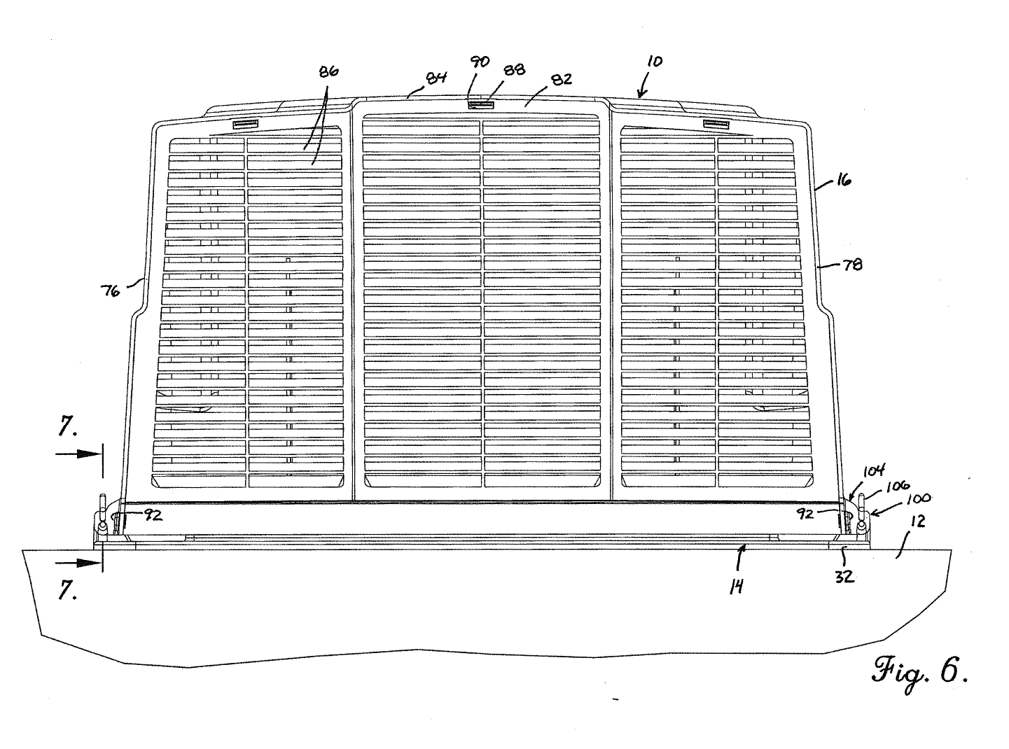

In one embodiment, the sidewalls 76 and 78, end wall 80 and top 84 are integrally formed as a one-piece, unitary unit and the end wall 82 is formed separately and is removable attached to the sidewalls 76 and 78, end wall 80 and top 84 to facilitate stacking of multiple rain covers 16 during shipping and to allow replacement of the end wall 82 if it should become damaged. The top 84 and optionally the sidewalls 76 and 78 include an inner recessed shoulder (not shown) against which the end wall 82 abuts. As can best be seen in FIGS. 3, 4, 6 and 8, the end wall 82 is held in place against the shoulder by fingers 88 that extend inwardly from an inner face of the end wall 82 along the top 84 and are removably interconnected with slots 90 formed in the shoulder.

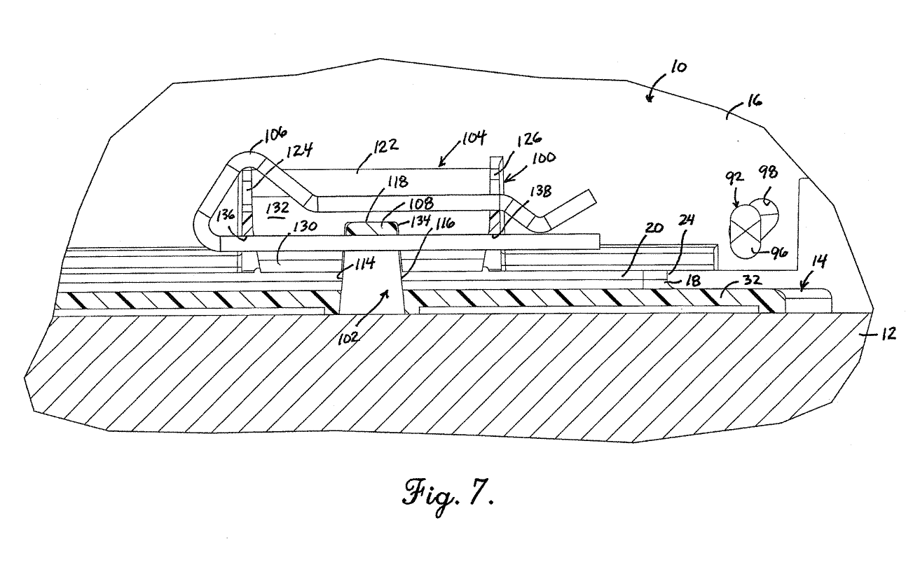

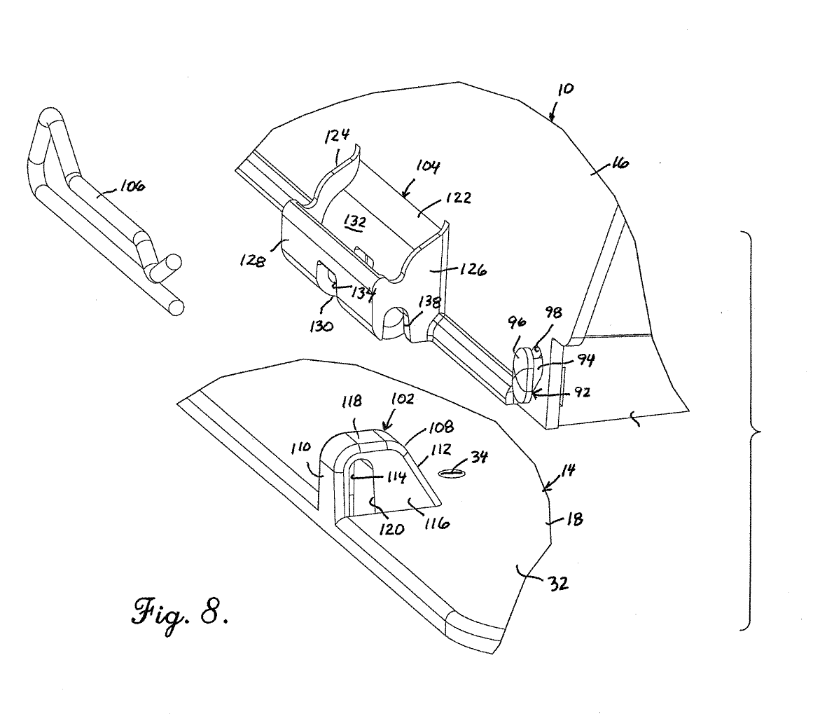

A lower portion of the end wall 82 is removably interconnected with the sidewalls 76 and 78 by knobs 92 that extend outwardly from opposite sides of the lower portion of the end wall 82. As can be seen in FIGS. 7 and 8, each knob 92 comprises a pin 94 that carries a head 96 that is oval-shaped or has another non-circular configuration. An oval slot 98 is positioned in each sidewall 76 and 78 in alignment with each knob 92 and is sized slightly larger than the head 96 to allow the head 96 to pass through the slot 98. Each pin 94 is only slightly longer than the thickness of each sidewall 76 and 78 so that after the head 96 has been inserted through the slot 98, the head 96 may be rotated so that it is no longer aligned with the slot, thereby preventing removal of the head 96 from the slot. In one embodiment, the knob 92 is fixed against movement to the end wall 82 so that the end wall 82 must be maneuvered to bring the long dimension of the head 96 into and out of alignment with the long dimension of the slot 98. In another embodiment, the head 96 or the entire knob 92 may be rotated with respect to the end wall 82 to cause inner surfaces of the head 96 to tightly engage outer surfaces of the associated sidewall 76 or 78 adjacent the slot 98. The frictional engagement of the inner surfaces of the head 96 against the outer surfaces of the sidewall 76 or 78 should be sufficient to prevent rotational movement of the head 96 under normal operating conditions while still permitting a person to manually rotate each knob 92 to cause engagement and disengagement of the inner surfaces of the head 96 against the outer surfaces of the sidewall 76 or 78 during installation and removal of the end wall 82. During installation of the end wall 82, the lower portions of the sidewalls 76 and 78 are flexed outwardly to provide sufficient clearance for the heads 96 to be placed in alignment with and the pass through the slots 98. The end wall 82 is then maneuvered into place against the recessed shoulder (not shown) to cause the fingers 88 to engage with the slots 90. The heads 96 are then misaligned with the slots 90, either as a result of the movement of the end wall 82 or independent movement of the heads 96 or knobs 92. Removal of the end wall 82 can be achieved by releasing the fingers 88 from the slots 90 and positioning the heads 96 so that they are aligned with and may pass back through the slots 90.

The rain cover 16 is removably attached to the air vent assembly 10 by a plurality of connector assemblies 100 that are positioned at the sides of the rain cover 16 and the air vent assembly 10. In the illustrated embodiment, two spaced-apart connector assemblies 100 are positioned at both sides of the rain cover 16 and the air vent assembly 10. The number and/or location of the connector assemblies 100 can be varied from the illustrated embodiment.

Each connector assembly 100 comprises a first connector portion 102 formed on the mounting flange 32 of the air vent 14, a second connector portion 104 formed on one of the sidewalls 74 and 76 or end wall 80 of the rain cover 16, and a fastener 106 that interconnects the first and second connector portions 102 and 104. The first connector portion 102 is integrally formed with the mounting flange 32 as a unitary, one-piece construction and extends upwardly from the mounting flange 32. The second connector portion 104 is integrally formed with the associated sidewall 74 or 76 or end wall 80 as a unitary, one-piece constructions and extends outwardly therefrom. The first connector portion 102 and the second connector portion 104 are positioned so that they are aligned with each other and may be interconnected by the fastener 106 when the rain cover 16 is placed in the intended registry with the air vent 14.

The first connector portion 102 of the connector assembly 100 comprises an upstanding tab 108 having an outer surface 110 that faces outwardly from the sidewall 20, 22 or 26 of the frame 18 closest to the tab 108 and an inner surface 112 the faces toward and is spaced from the associated sidewall 20, 22 or 26. The tab 108 further includes a front face 114 and a rear face 116 that extend between the outer and inner surfaces 110 and 112 and a top surface 118 that extends between top edges of the outer and inner surfaces 110 and 112. The outer surface 110 and the front and rear faces 114 and 116 extend generally perpendicularly upward from the upper surface of the mounting flange 32 and the inner surface 112 slopes outwardly toward the outer surface 110 such that the inner surface 112 is spaced further from the associated frame sidewall 20, 22 or 26 at its upper edge than at its lower edge. The tab 108 includes an aperture 120 that extends between the front and rear faces 114 and 116. In one embodiment, the aperture 120 is in the form of a closed-ended slot that has a greater vertical dimension than horizontal dimension.

The second connector portion 104 of the connector assembly 100 comprises a foot 122 having spaced-apart front and rear walls 124 and 126 that are interconnected by an outer wall 128 that is spaced from the associated sidewall 72 or 74 or end wall 78 of the rain cover 16 and a bottom wall 130 that is joined to the outer wall 128. The second connector portion 104 also includes an inner wall 132 that is spaced inwardly from the outer wall 128 and is interconnected with the front and rear walls 124 and 126 and the bottom wall 130. A notch 134 is formed in the outer wall 128, the bottom wall 130 and the inner wall 132 and is positioned to tightly receive the tab 108. The insertion of the tab 108 into the notch 134 serves to align the rain cover 16 to the air vent 14 in the desired mating relationship. Initial location of the tab 108 in the notch 134 is facilitated by the sloped inner surface 112 that causes the top surface 118 of the tab 108 to have a small cross-sectional area than the base of the tab 108.

The front wall 124 includes an opening 136 positioned above the bottom wall 130 and sized to permit insertion of the fastener 106. The rear wall 126 includes a similar opening 138 that is aligned with the opening 136 in the front wall 124 to permit the fastener 106 to be inserted through both openings 136 and 138. When the tab 108 is received within the notch 134, the aperture 120 in the tab 108 is aligned with the openings 136 and 138 to permit the fastener 106 to also be inserted through the aperture 120. The fastener 106 may take any of various suitable forms, including the illustrated cotter pin. By inserting the fastener 106 through the openings 136 and 138 and the aperture 120, the fastener 106 serves to interconnect the first and second connector portions 102 and 104 to secure the rain cover 16 to the air vent 14 and thereby foil the air vent assembly 10. The fastener 106 may later be removed to permit disconnection of the first and second connector portions 102 and 104 and separation of the rain cover 16 from the air vent 14.

Notably, the connector assemblies 100 allow the rain cover 16 to be releasably joined to the air vent 14 by lowering the rain cover 16 onto the air vent 14 and positioning the tabs 108 within the notches 134. The fasteners 106 are then inserted through the aligned openings 136 and 138 and the apertures 120. The removal of the rain cover 16 from the air vent 14 can be quickly achieved by removing the fasteners 106 and then lifting the rain cover 16 off of the air vent 14.

From the foregoing, it will be seen that this invention is one well adapted to attain all the ends and objectives hereinabove set forth together with other advantages that are inherent to the structure.

It will be understood that certain features and subcombinations are of utility and may be employed without reference to other features and subcombinations. This is contemplated by and is within the scope of the invention.

Since many possible embodiments may be made of the invention without departing from the scope thereof, it is to be understood that all matter herein set forth or shown in the accompanying drawings is to be interpreted as illustrative and not in a limiting sense.

What is claimed is:

1. An air vent assembly comprising:
an air vent comprising:
a frame formed by interconnected sidewalls;
a mounting flange that extends outwardly from the sidewalls; and
a ventilation passage formed within the frame;
a rain cover formed from interconnected sidewalls, end walls and a top and being generally open at the bottom, wherein one of the end walls is open to the passage of air; and
at least one connector assembly for removably attaching the rain cover to the air vent, said connector assembly comprising a first connector portion formed on the mounting flange, a second connector assembly formed on one of the sidewalls or end walls of the rain cover, and a fastener that interconnects the first connector portion with the second connector portion.

2. The air vent assembly of claim 1, wherein the first connector portion is integrally formed with the mounting flange as a unitary, one-piece construction.

3. The air vent assembly of claim 2, wherein the second connector portion is integrally formed with the sidewall or end wall of the rain cover as a unitary, one-piece construction.

4. The air vent assembly of claim 3, wherein the first connector portion comprises an upstanding tab having an inner surface that faces toward and is spaced from one of the sidewalls of the frame and an outer surface that faces outwardly from said one of the sidewalls of the frame.

5. The air vent assembly of claim 4, wherein the second connector portion comprises a foot having a notch positioned to tightly receive the tab of the first connector portion.

6. The air vent assembly of claim 5, including an opening in the foot and an aperture in the tab that is aligned with the opening in the foot, wherein the fastener is removably inserted through the opening and the aperture to interconnect the first and second connector portions and removably secure the rain cover to the air vent.

7. The air vent assembly of claim 6, including a vent fan positioned in the ventilation passage of the air vent.

8. The air vent assembly of claim 7, wherein the end wall of the rain cover that is open to the passage of air includes outward-facing knobs having oval heads that are removably received within oval slots in the sidewalls of the rain cover and may be positioned to align with and pass through the oval slots and then rotated out of alignment with the oval slots to prevent the oval heads from passing through the oval slots to thereby removably secure the end wall to the sidewalls.

9. An air vent assembly comprising:
an air vent comprising:
a frame formed by interconnected sidewalls;
a mounting flange that extends outwardly from the sidewalls; and
a ventilation passage formed within the frame;
a vent fan positioned to convey air through said ventilation passage;
a rain cover formed from interconnected sidewalls, end walls and a top and being generally open at the bottom, wherein one of the end walls is open to the passage of air; and
at least one connector assembly for removably attaching the rain cover to the air vent, said connector assembly comprising a first connector portion formed on the mounting flange, a second connector assembly formed on one of the sidewalls or end walls of the rain cover, and a fastener that interconnects the first connector portion with the second connector portion.

10. The air vent assembly of claim 9, wherein the first connector portion is integrally formed with the mounting flange as a unitary, one-piece construction.

11. The air vent assembly of claim 10, wherein the second connector portion is integrally formed with the sidewall or end wall of the rain cover as a unitary, one-piece construction.

12. The air vent assembly of claim 11, wherein the first connector portion comprises an upstanding tab having an inner surface that faces toward and is spaced from one of the sidewalls of the frame and an outer surface that faces outwardly from said one of the sidewalls of the frame.

13. The air vent assembly of claim 12, wherein the second connector portion comprises a foot having a notch positioned to tightly receive the tab of the first connector portion.

14. The air vent assembly of claim 13, including an opening in the foot and an aperture in the tab that is aligned with the opening in the foot, wherein the fastener is removably inserted through the opening and the aperture to interconnect the first and second connector portions and removably secure the rain cover to the air vent.

15. The air vent assembly of claim 14, wherein the end wall of the rain cover that is open to the passage of air includes outward-facing knobs having oval heads that are removably received within oval slots in the sidewalls of the rain cover and may be rotated to frictionally engage with the sidewalls to removably secure the end wall to the sidewalls.

16. An air vent assembly comprising:
an air vent comprising:
a frame formed by interconnected sidewalls;
a mounting flange that extends outwardly from the sidewalls; and
a ventilation passage formed within the frame;
a vent fan positioned in the ventilation passage of the air vent;
a rain cover formed from interconnected sidewalls, end walls and a top and being generally open at the bottom, wherein one of the end walls is open to the passage of air; and
at least one connector assembly for removably attaching the rain cover to the air vent, said connector assembly comprising a first connector portion formed on the mounting flange, a second connector assembly formed on one of the sidewalls or end walls of the rain cover, and a fastener that interconnects the first connector portion with the second connector portion,
wherein the end wall of the rain cover that is open to the passage of air includes outward-facing knobs having heads that are removably received within slots in the sidewalls of the rain cover and may be positioned to align with and pass through slots and then rotated out of alignment with the slots to prevent the heads from passing through the slots, thereby removably securing the end wall to the sidewalls.

17. The air vent assembly of claim 16, wherein the first connector portion is integrally formed with the mounting flange as a unitary, one-piece construction and the second connector portion is integrally formed with the sidewall or end wall of the rain cover as a unitary, one-piece construction.

18. The air vent assembly of claim 17, wherein the first connector portion comprises an upstanding tab having an inner surface that faces toward and is spaced from one of the sidewalls of the frame and an outer surface that faces outwardly from said one of the sidewalls of the frame.

19. The air vent assembly of claim 18, wherein the second connector portion comprises a foot having a notch positioned to tightly receive the tab of the first connector portion.

20. The air vent assembly of claim 19, including an opening in the foot and an aperture in the tab that is aligned with the opening in the foot, wherein the fastener is removably inserted through the opening and the aperture to interconnect the first and second connector portions and removably secure the rain cover to the air vent.
